(19) United States
(12) Patent Application Publication
(10) Pub. No.: US 2022/0027857 A1
(43) Pub. Date: Jan. 27, 2022

(54) INTERACTIVE PEER-TO-PEER REVIEW SYSTEM

(71) Applicant: SWYG Limited, Dublin (IE)

(72) Inventor: Vincent Petrus Anthonius LONIJ, Dublin (IE)

(21) Appl. No.: 17/377,715

(22) Filed: Jul. 16, 2021

Related U.S. Application Data
(60) Provisional application No. 63/054,497, filed on Jul. 21, 2020.

(51) Int. Cl. G06Q 10/10; G06Q 10/06; H04L 29/06

(52) U.S. Cl. CPC G06Q 10/1053; H04L 65/403; G06Q 10/06393; G06Q 10/06398

(57) ABSTRACT

Systems and methods are disclosed for interactive peer-to-peer reviews. Techniques disclosed assign participants, set to interact with each other via a communication system, into groups; each group comprises participants that set to interact in a group session as a reviewer or as a reviewee. Each participant in a group is provided with instructions, based on which the participant interacts with another participant in the group during a respective group session. Calibration data are generated based on feedback data associated with the interactions among the participants during respective group sessions. The calibration data may be used to calibrate the interactions in ongoing sessions by updating the instructions provided to the participants in the group sessions.

### CROSS FOR PRIORITY

This application claims to U.S. Provisional Patent Application No. 63/054,497, filed on Jul. 21, 2020, entitled “Interactive Peer-To-Peer Review System”, the disclosure of which is incorporated herein by reference in its entirety.

### BACKGROUND

The present disclosure relates to a computer system that supports real-time peer-to-peer interactions among interview candidates, capture of interactions and review data from those candidates, and evaluation of such candidates.

The accessibility of a large number of candidates to an online posted job complicates the process of reviewing applicants' credentials and identifying suitable talents. The review of a large number of candidates for a position may be a time-consuming process and may be inaccurate if done without personal interactions with individual candidates. Automated systems that provide recruiters with applicants' pre-recorded videos to be reviewed off-line lack the benefit of interactive review sessions. Systems are needed that provide scalable mechanisms for interactive reviews of candidates with means to calibrate interactions during ongoing review sessions.

### BRIEF DESCRIPTION OF THE DRAWINGS

FIG. 1 illustrates an interactive peer-to-peer review system, according to an aspect of the present disclosure.

FIG. 2 is a block diagram of a peer-to-peer review system, according to an aspect of the present disclosure.

FIG. 3 is a method for interactive peer-to-peer review, according to an aspect of the present disclosure.

FIG. 4 is a method for assigning participants of a peer-to-peer review system into group sessions, according to an aspect of the present disclosure.

FIG. 5 illustrates a review process, according to an aspect of the present disclosure.

FIG. 6 shows a client-application's display as viewed by a session participant who is assuming the role of an interviewer, according to an aspect of the present disclosure.

FIG. 7 shows a client-application's display as viewed by a session participant who is assuming the role of a candidate, according to an aspect of the present disclosure.

FIG. 8 is a method for computing skill-scores and judgement-scores for participants, users of a peer-to-peer review system, according to an aspect of the present disclosure.

FIG. 9 is a block diagram of a peer-to-peer review system, according to an aspect of the present disclosure.

FIG. 10 demonstrates data structures of reviews provided by participants of a group session, according to an aspect of the present disclosure.

FIG. 11 demonstrates a data structure of subject matter related questions and associated keywords, according to an aspect of the present disclosure.

### DETAILED DESCRIPTION

Systems and methods are disclosed for capture and evaluation of interactive peer-to-peer reviews in an online environment. The system may assign participants, set to interact with each other via a communication system, into groups; each group may comprise participants set to interact in a group session as a reviewer or as a reviewee. The system may provide instructions to each participant in a session that determine how the participant interacts within the session. As the participants perform their instructions during a session, the system may receive feedback data, including reviews provided by the participants and video/audio captures of the interactions among the participants. The system may calibrate its instructions to each participant based on the feedback data. The system may apply feedback data dynamically to the sessions by, for example, selecting new instructions or altering instructions provided to a participant within an ongoing session. Further, the system may apply the feedback data to consecutive rounds of sessions by, for example, controlling the manner in which participants may be assigned to groups and the role each participant is assigned to in each round.

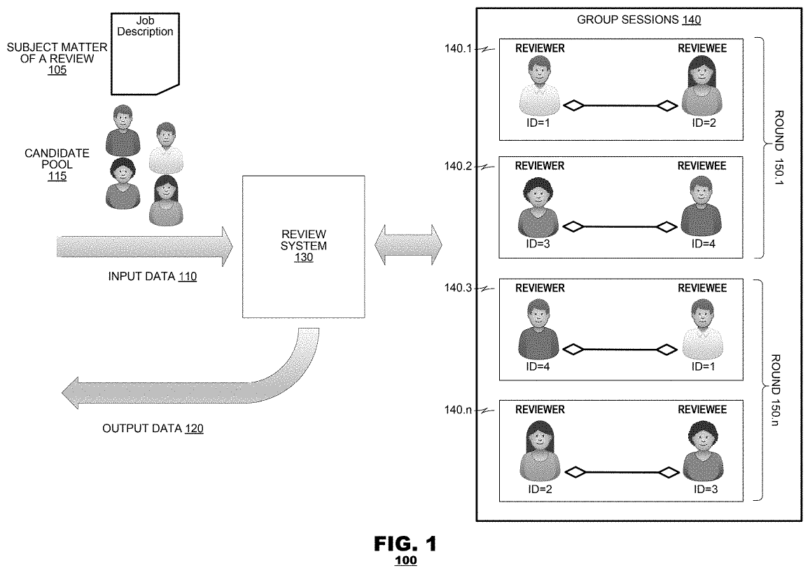

FIG. 1 illustrates an interactive peer-to-peer review system 100 according to an aspect of the present disclosure. A review system 130 may receive input data 110, including a pool of participants (candidates) 115 and information related to a subject matter (e.g., a job description) 105 with respect to which the participants 115 are to be evaluated. The review system 130 may invite the participants 115 to log into the system and may enable the participants to communicatively link with each other. Thus, according to aspects described herein, the participants may be able to connect and interact with each other in group sessions 140; in each group session, the system 130 may assign one participant of the group to a “reviewer” role and a second participant to a “reviewee” role. During a group session, participants of the group may be instructed by the system 130 with respect to interactions each participant may initiate with (or respond to) another participant in the group, according to each participant's role in the session. For example, an instruction may direct a reviewer to pose a question that elicits a response by a reviewee indicative of a skill level associated with the subject matter under review 105. Such instructions may be prompted by the system 130 during a group session based on real-time calibration data that may be generated by the system 130. These calibration data may be derived from feedback data associated with the interactions between the participants during the group session. As explained in detail below, feedback data may be collected by the system 130 during the sessions, including review data provided by the participants and data generated by analyses of video/audio data captures of the sessions. The feedback data may also be used by the system 130 to generate output data 120, including evaluation data that, for example, assess the participants' competency with respect to the subject matter under review 105.

In an aspect, participants engaged by the review system 130 may be candidates for a position offered by a company. In such a scenario, the company may provide the system 130 with input data 110, including data representing a pool of candidates 115 and information related to the subject matter under review 105—e.g., a description of an offered position, including the required skills, background, and experience for the offered position, and/or specific topics each candidate should be evaluated against. The review system 130 may schedule and orchestrate multiple rounds 150.1-150.n of interactive sessions 140 among the candidates; in each round, the system may assign the candidates to different group sessions—e.g., sessions 140.1-140.2 in round 150.1 and sessions 140.3-140.n in round 150.n—wherein, in each session 140.1, 140.2, . . . , 140.n, one candidate will assume a role of a reviewer and another candidate a role of a reviewee. Furthermore, during a session, the system 130 may control (calibrate) the interactions among the candidates in real-time, as explained in detail below. In an aspect, a subset of the participants that are engaged by the review system 130 may be employees of the company that offers the position, serving as benchmark-participants. Such benchmark-participants may be assigned a reviewee role, a reviewer role, or a combination thereof. In another aspect, the benchmark-participants may be independent experts in the subject matter under review 105.

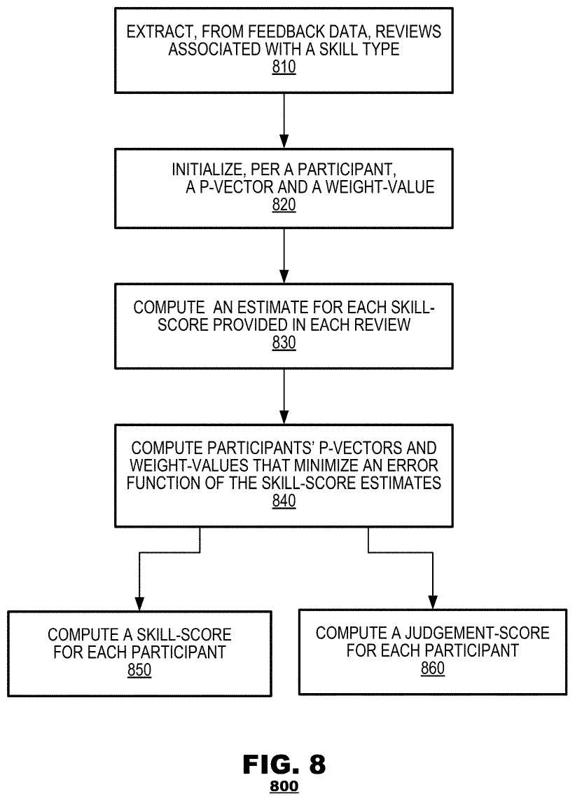

Thus, in the span of several rounds 150.1-150.n, a single participant may act as a reviewer across multiple sessions of 140.1-140.n, interacting with (e.g., interviewing) other participants that act as reviewees. Similarly, the same participant may act as a reviewee in other sessions of 140.1-140.n, providing interview responses to questions posed by the reviewers of those sessions. As explained in detail below, during the multiple sessions, the system 130 may collect feedback data, comprising reviews provided by the sessions' participants—each review scores the response(s) to interaction(s) with respect to a certain tested skill. Based on these reviews, the system 130 computes for each candidate skill-scores, measuring the candidate's performance with respect to subject matter competency (e.g., responses' completeness and accuracy) as well as communication skills. The system 130 may generate output data 120, providing to the company each candidate's computed skill-scores. The system 130 may also compute each candidate's judgement-score and may use this score to determine the assignment of the candidate into future group sessions and the role each participant will assume in these sessions. An aspect for computing a participant's skill-score and judgement-score with respect to a certain skill is described in detail with respect to FIG. 8.

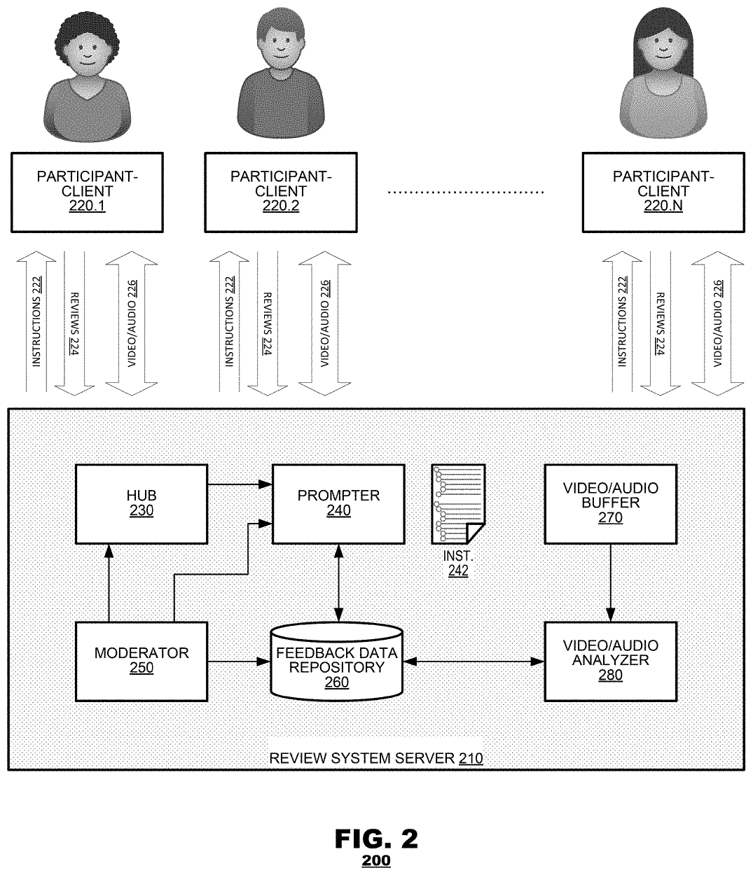

FIG. 2 is a block diagram of a peer-to-peer review system 200 according to an aspect of the present disclosure. The system 200 may comprise a review system server 210 and client devices 220.1-220.N used by participants that may be engaged in the peer-to-peer review. The server 210 and each of the client devices 220.1-220.N may be communicatively link via a communication network, e.g., internet, or cellular communication. A client device may be a desktop computer, a laptop, a mobile device, or other consumer electronic devices, supporting teleconferencing applications that interface with the review system 210 disclosed herein. Thus, participants of respective clients 220.1-220.N that are logged-into the server 210 may be connected to each other and may be able to communicate with each other via video, audio, and text messages, in a manner that is scheduled and controlled by the review system 210 and methods described herein.

The review system 210 may comprise a hub 230, a prompter 240, a moderator 250, a feedback data repository 260, a video/audio buffer 270, and a video/audio analyzer 280. The hub 230 may control the scheduling of rounds 150.1-150.n of review sessions. The hub, 230 may be fed with log-in data of participants to be reviewed and may output assignment data, specifying the assignment of participants into the review sessions and the assignment of roles—a reviewer or a reviewee—to each participant. The hub 230 may include a communication manager to establish teleconferences between client devices 220.1-220.N of participants in each group session. For example, in round 150.1, the hub may assign participant 1 and 2 to session 140.1 and participants 3 and 4 to session 140.2, wherein participants 1 and 3 will be assigned with the role of a reviewer and participants 2 and 4, will be assigned with the role of a reviewee. Likewise, in round 150.n, the hub may assign participant 4 and 1 to session 140.3 and participants 2 and 3 to session 140.n, wherein participants 2 and 4 will be assigned with the role of a reviewer and participants 1 and 3, will be assigned with the role of a reviewee.

Once the hub 230 connects participants' client devices (e.g., 220.1 and 220.2) according to their respective assigned groups, the prompter 240 may control the review sessions of the groups in real-time. The prompter 240, may be fed with the assignment data generated by the hub 230 and may output instructions 222 to the participants' client devices, based on which the participants may interact, each in her respective ongoing session. Such instructions may be drawn from a list of instructions 242. The instructions 222 may include, for example, questions that a participant acting as a reviewer is to ask a participant acting as a reviewee in order to collect desired subject matter responses, for example, information regarding a skill desired from reviewees. Based on the reviewee's response, the reviewer may score the skill level of the reviewee. Additionally, the prompter 240 may provide further instructions to a reviewer, e.g., based on responses of the reviewee to questions presented to her by the reviewer, guiding the reviewer to initiate a follow-up interaction. Likewise, the prompter 240 may provide further instructions to a reviewee, guiding her interactions with the reviewer. In an aspect, the prompted instructions may be based on calibration data generated by the moderator component 250.

The moderator 250 may access feedback data from the repository 260, associated with the participants' interactions and may output calibration data generated based on the feedback data. The feedback data may be collected based on reviews 224 provided by the participants during respective ongoing sessions. Feedback data 224 may also include features extracted from video and/or audio 226, exchanged between the client devices 220.1-220.N during respective sessions. The exchanged video and/or audio 226 may be buffered in the video/audio buffer 270. The video/audio analyzer 280 may analyze the buffered video and/or audio content and may convert such content to data for analysis. Analyses of video and/or audio content may include extracting features indicative of the quality of the interaction it captures. For example, the analyzer 280 may apply speech-to-text conversion applications to develop audio transcription of a reviewee's responses to posed questions, which may be stored in the feedback data repository 260 as the reviewee's feedback data. Similarly, the analyzer 280 may apply speech-to-text conversion applications to develop audio transcription of questions posed by reviewers, which may be stored in the feedback data repository 260 as a reviewer's feedback data. Further analyses may include extracting features—key-phrases or keywords—from the audio transcriptions that may also be stored in the repository.

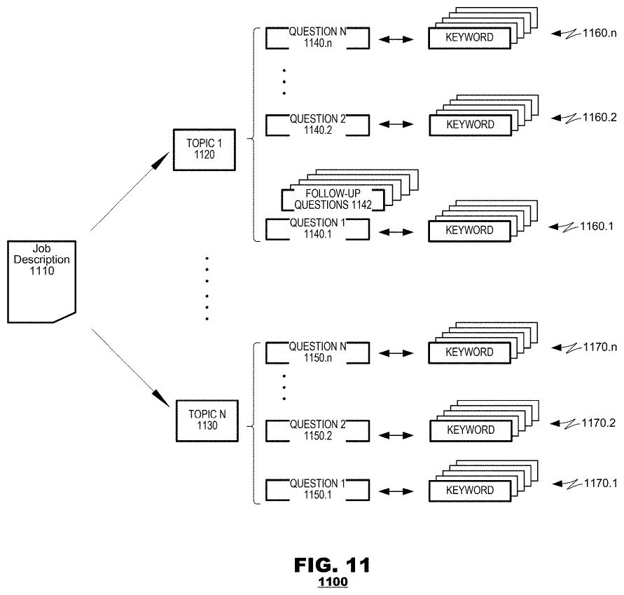

In an aspect, the moderator 250 may access the keywords (and/or key-phrases) extracted from the transcription of an audio that captures a reviewee's response to a currently posed question and may compare these extracted keywords (and/or key-phrases) to keywords (and/or key-phrases) that are relevant to the currently posed question. As illustrated in FIG. 11, with respect to keywords, a given job description 1110 (subject matter of a review 105) may be associated with topics 1120, 1130 that participants 220.1-220.N may be evaluated against. Each topic may further be associated with a list of questions. For example, topic 1120 may be associated with a list of questions 1140.1-1140.n and topic 1130 may be associated with a list of questions 1150.1-1150.n. Furthermore, each question may be mapped to a list of relevant keywords, e.g., question 1140.1 may be mapped to a list of keywords 1160.1. The identification of topics 1120, 1130, the respective lists of questions 1140.1-1140.n, 1150.1-1150.n and the respective lists of keywords 1160.1-1160.n, 1170.1-1170.n, may be done manually by the system's 210 operator at initialization stage, or by automatic analyses of the subject matter of the review 105.

Thus, in an aspect, the moderator 250 may compare keywords extracted from an audio transcription with a list of keywords (e.g., 1160.1) associated with the currently posed question (e.g., 1140.1) and may measure the degree of match, for example by employing semantic matching. Based on the degree of match, the moderator 250 may conclude to what degree the interviewee's response is complete—that is whether calibration is needed to improve the interactions in the session. Thus, based on the comparison, the moderator 250 may generate calibration data that may trigger the prompter 240 to issue further instructions to the reviewer to initiate follow-up questions 1142 to the reviewee. The calibration data may include the measured degree of match or keywords in the list 1160.1 that are missing from the extracted keywords (i.e., from the transcription of the audio that captures the reviewee's response to the currently posed question 1140.1). Based on the calibration data, the prompter may decide what further instructions to provide the reviewer, e.g., what further follow-up questions from an available list of questions 1142 the reviewer should be prompted with. The concepts described above with respect to the keywords in FIG. 11, may be applied with respect to key-phrases.

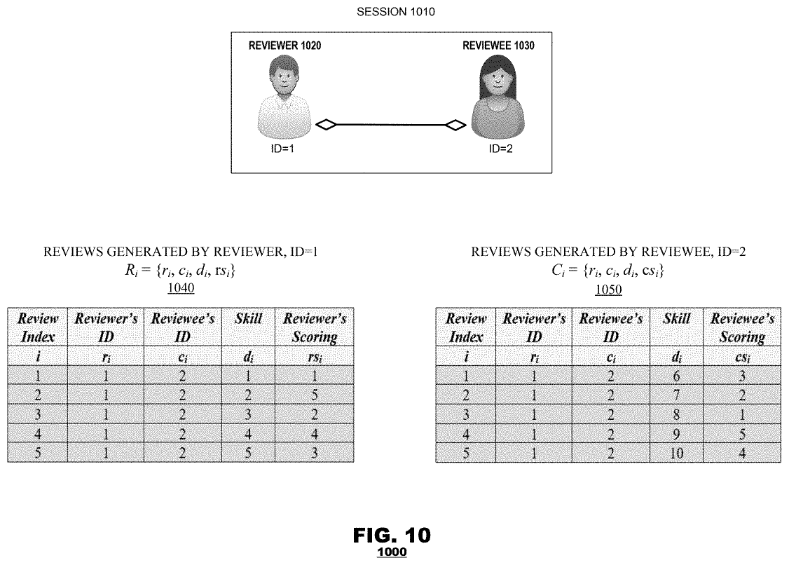

The feedback data repository 260 may store review data 224 provided by the participants during the review sessions (e.g., 1040 and 1050 of FIG. 10). The repository may also store features that are extracted from video and/or audio 226 of the ongoing sessions and/or features that were extracted from video and/or audio of past sessions. As explained in detail below, data stored in the repository of previous sessions may be used to train machine learning based models that may be used in the evaluation of the participants in the current sessions.

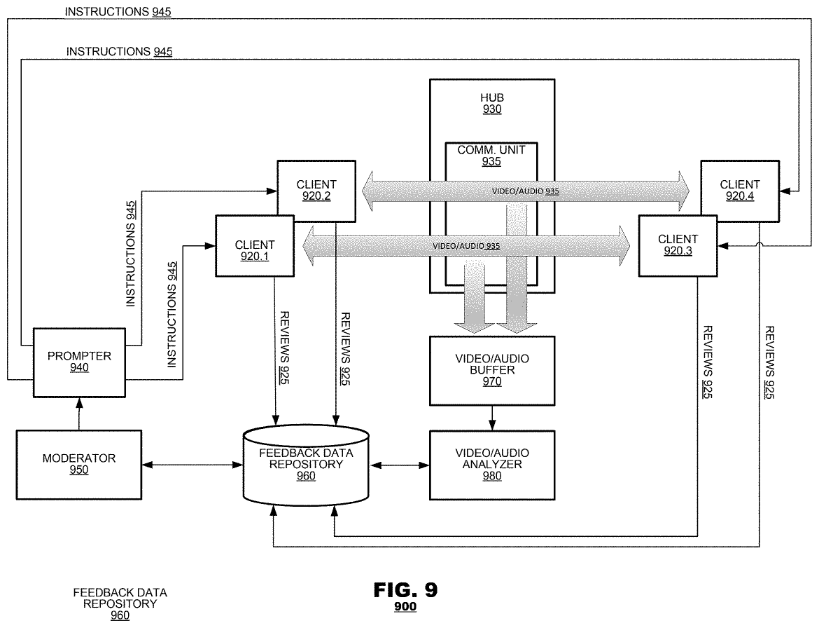

FIG. 9 is a block diagram of a peer-to-peer review system 900, according to an aspect of the present disclosure. System 900 may comprise the review system server 210 of FIG. 2 and client devices 920.1-920.4 (of 220.1-220.N of FIG. 2) used by participants that may be engaged in the peer-to-peer review. Participants of respective clients 920.1-920.4 may be logged-into a hub 930. The hub 930 may facilitate communications between the participants 920.1-920.4 via video, audio, and text messages, in a manner that is scheduled and controlled by the system 900 and methods described herein.

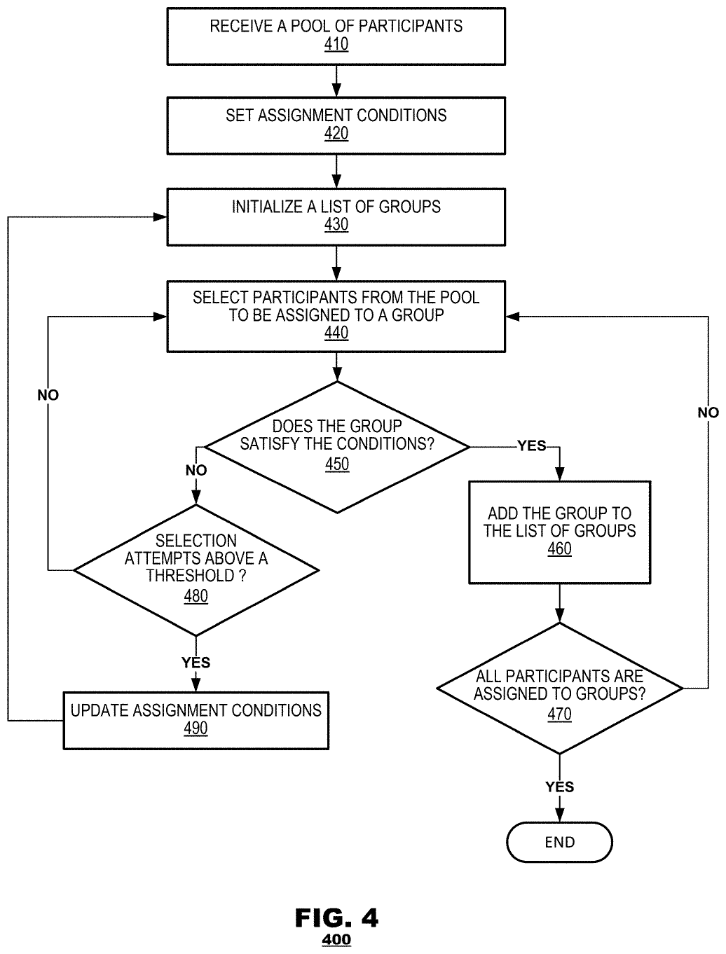

The system 900 may comprise a hub 930, a prompter 940, a moderator 950, a feedback data repository 960, a video/audio buffer 970, and a video/audio analyzer 980. The hub 930 may control the scheduling of rounds 150.1-150.n of review sessions 140; in each round, the hub may assign participants into groups 140.1-140.n, as disclosed with respect to FIG. 4. Thus, the hub 930 may include a communication unit 935 capable of connecting participants that are assigned to the same group to enable them to teleconference 935 with each other according to aspects disclosed herein. For example, in a round, the hub may assign participants 920.1 and 920.3 into a first group session and participants 920.2 and 920.4 into a second group session, wherein participants 920.1 and 920.2 may be assigned with the role of a reviewer and participants 920.3 and 920.4 may be assigned with the role of a reviewee. Once assigned to their respective group sessions, the participants may be communicatively linked 935 by the system 900.

Once participants are connected according to their respective assigned groups, the prompter 940 may control the review process in real-time. The promoter 940 may present the participants 920.1-920.4 with instructions 945 guiding interactions among participants in each group session. Such instructions may include, for example, questions a reviewer may ask a reviewee in order to review a certain skill. Further, the instructions provided by the prompter 940 may be according to a predefined number of instructions at a predefined rate. For example, instructions 945 provided by the prompter 940 during an ongoing session may be based on responses of the reviewee (e.g., as captured in video and/or audio 935) to questions presented by the reviewer, guiding the reviewer to initiate a follow-up interaction. In an aspect, the prompted instructions 945 may be based on calibration data generated by the moderator 950.

The moderator 950 may generate calibration data based on analyses of feedback data 960 collected in real time during an ongoing session. Video and/or audio 935 that may be recorded and buffered 970 during a session may be used to guide the interactions of the participants in the session. For example, the system 900 may buffer 970 the teleconferencing video and/or audio 935 of an ongoing session and may analyze 980 the video and/or audio 935 content during a time-window that corresponds to a reviewee's response to a posed question. Such analyses may include extracting features, such as phrases or keywords. The extracted phrases or keywords may be stored in the repository 960. The moderator 950 may then access the extracted phrases or keywords and may compare them with phrases or keywords that are relevant to the currently posed question, as explained with respect to FIG. 11. Based on the comparison, the moderator 950 may generate calibration data that may trigger the prompter 940 to issue further instructions 945 to the reviewer 920.1-920.2 to initiate follow-up questions to the reviewee 920.3-920.4. Further instructions 945 may also be issued to the reviewee 920.3-920.4, for example, to initiate or conclude an interaction.

The feedback data repository 960 may store the review data 925 provided by the participants 920.1-920.4 during the review sessions (e.g., 1040 and 1050 of FIG. 10). The repository may also store features (e.g., phrases or keywords) that are extracted from the video and/or audio 935 of the ongoing sessions and/or features that were extracted from video and/or audio of past sessions.

The hub 930, may connect the participants 920.1-920.4 into groups and may access the video/audio data 935 that capture the participants' interactions, according to aspects disclosed herein. In an aspect, the hub 930 may provide each of the participants' client devices 920.1-920.4 with information enabling it to connect to a third party's video chat service and may instruct the third party's platform to stream to the hub the video/audio data that capture the interactions of the participants via the third party's platform. In another aspect, the hub 930 may instruct the participants' client devices 920.1-920.4 to connect to the third party's platform and, simultaneously, the hub may connect to the same chatroom as the client devices and “listen” to the audio/video channels in that chatroom. In yet another aspect, the hub 930 itself may provide a video chat service 935, in which case, the video/audio exchange between the participants may flow from a client device (e.g., 920.1) to the hub 930 and may then be retransmitted by the hub to another client device (e.g., 920.3). A client device may use WebRTC to transmit the video/audio to the hub (which the hub then may retransmit to the other clients). The hub may comprise platform components that may share data by using a shared data layer (e.g. AWS S3, Redis), using message queues (e.g. RabbitMQ, Redis), using WebRTC or other video streaming protocol, using remote procedure calls (RPC), or a combination thereof.

As illustrated in FIG. 9, participants' client devices 920.1-920.4 may send review data 925 to the review system server 210 to be stored in the repository 960. In an aspect, the review data 925 may be transmitted by a client, where the client may send queries to a REST API or a GraphQL API that may be implemented on the server 210. Further, as illustrated in FIG. 9, participants' client devices 920.1-920.4 may receive instruction data 945 from the prompter 940 of the server 210. In an aspect, instruction data 945 may be received by the client by having the client periodically poll a REST of GraphQL API on the server. Alternatively, the client may use WebRTC to connect to the server and listen for updated instructions, or the client may use remote procedure calls (RPC).

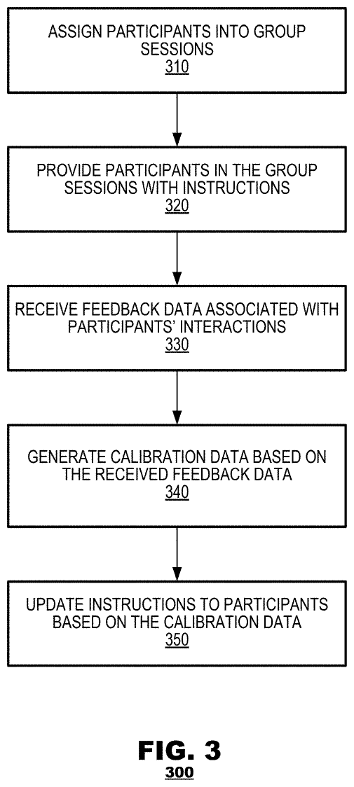

FIG. 3 shows a method 300 for interactive peer-to-peer review, according to an aspect of the present disclosure. The method 300 may begin with assigning participants 220.1-220.N into group sessions, according to an aspect described herein (Box 310). The method 300 may then provide the participants with instructions that guide the interactions among participants based on their role (reviewer or reviewee) in the group they are assigned to (Box 320). During these sessions (carried out by the participants in each group), the method 300 may receive feedback data associated with the participants' interactions in the respective sessions (Box 330). The feedback data may comprise reviews provided by the participants as well as data extracted from video and/or audio recordings of the sessions. The method 300 may generate calibration data based on the received feedback data (Box 340). Based on the calibration data, the method 300 may update (calibrate) the instructions provided to the participants, guiding the manner in which the participants interact with each other during their respective ongoing sessions (Box 350).

FIG. 4 shows a method 400 for assigning participants into group sessions, according to an aspect of the present disclosure. Method 400 may be an aspect of Box 310 of FIG. 3 and may be carried out by the hub 230 of the review system 210 of FIG. 2. The method 400 may begin with receiving a pool of participants 115 (Box 410). The method 400 may set conditions that each assignment of participants into a group has to meet (Box 420). This set of conditions may also dictate in what role each participant is assigned to in each group. A list that stores groups and their assigned participants may be initialized by the method (430). Then, the method 400 may select from the pool a number of participants to be assigned to a group (Box 440). For example, two participants—one to serve as a reviewer and the other to serve as a reviewee—may be randomly sampled from the pool of available participants 115. If the selected group satisfies the conditions (Box 450), the group is added to the list of assigned groups (Box 460), and if some participants are not yet assigned (Box 470), the method 400 may continue to select another group from the pool (Box 440). Otherwise, if all the participants are already assigned to respective groups (Box 470), the method 400 may end. If the selected group does not satisfy the conditions (Box 450), the method 400 may continue to select another group from the pool (Box 440), given that the number of attempts to assign participants into groups has not reached a predetermined threshold (Box 480). If the number of attempts to assign participants into groups is above the predetermined threshold (Box 480), the method 400 may update the assignment conditions (Box 490) and may start the process again, starting with initializing the list of groups (Box 430).

In an aspect, method 400 may carry out assignments of participants 115 into group sessions 140 in multiple rounds. Various assignment conditions may be set (Box 420 and Box 490). For example, according to a first condition, participants may not be assigned with the same role in two consecutive rounds. A second condition may require that participants may not interact with the same participant more than once (e.g., a reviewer may review another reviewee only once). A third condition may require that all participants have to serve as a reviewer and as a reviewee a certain number of times or within a range of a number of times. A fourth condition may be that in each round at least a certain number of, or all, participants are assigned into groups. Other conditions may be used to constrain the manner in which the participants are grouped into sessions and in what role, in accordance with method 400.

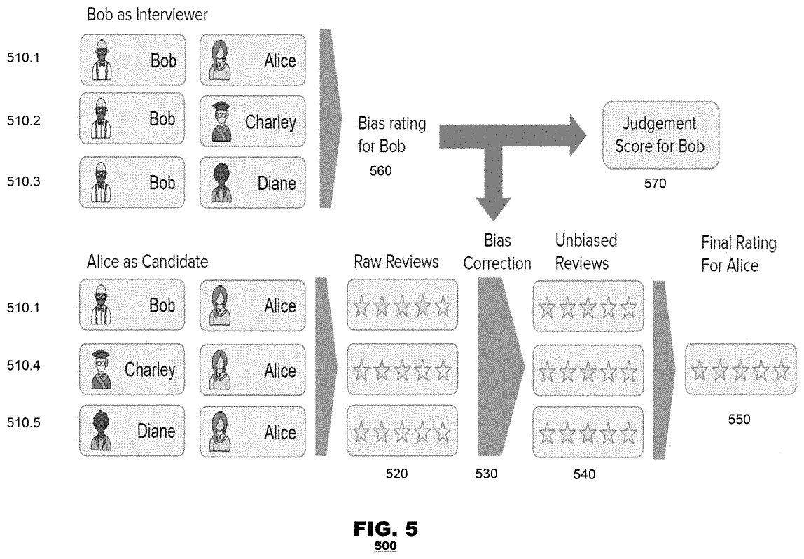

FIG. 5 illustrates a review process, according to an aspect of the present disclosure. Five sessions are demonstrated in FIG. 5. In sessions 510.1, 510.2, and 510.3, Bob assumes the role of a reviewer and Alice, Charley, and Diane assume the role of reviewees, respectively. In sessions 510.4 and 510.5, Charley and Diane assume the role of a reviewer and Alice assumes the role of a reviewee. For example, in the sessions for which Alice is a reviewee, i.e., 510.1, 510.4, and 510.5, Alice may respond to interactions made by the respective reviewers, Bob, Charley, and Diane. Each of these respective reviewers may initiate interactions according to instructions provided to them by the prompter 240 and may provide a review (score) of the responses provided by Alice. Thus, each session, 510.1-510.5, may generate review data (i.e., reviews), that may be provided by a reviewer, including information such as: the reviewer identity, rᵢ, the reviewee identity, the skill under review by the reviewer, dᵢ, and the reviewer's scoring, i.e., skill-score, rsᵢ. Similarly, each session, 510.1-510.5, may generate review data, that may be provided by a reviewee, including information such as: the reviewer identity, rᵢ, the reviewee identity, the skill under review by the reviewee, dᵢ, and the reviewee's scoring, i.e., skill-score, csᵢ. Accordingly, as further explained with respect to FIG. 10, each review, i, in a session, may result in a review vector Rᵢ={rᵢ, cᵢ, dᵢ, rsᵢ} or Cᵢ={rᵢ, cᵢ, dᵢ, rsᵢ} that may be stored in the feedback data repository 260 for further processing by the moderator 250.

The reviews of a certain reviewee, for example Alice in FIG. 5, possibly, may be biased by the reviewers who generated them, Bob, Charley, and Diane. These possibly biased reviews, denoted as raw reviews 520, may be corrected for bias 530, and the unbiased reviews 540 may be then assembled into a final review 550. The bias of each participant may be derived from review data that was generated by sessions in which the participant served as a reviewer. For example, Bob's bias as a reviewer 560 may be derived from review data generated by sessions 510.1-510.3. In an aspect, the bias derived for each participant may be used for both bias correction 530 and for computing the participant's judgement-score 570. The participant's judgement-score, e.g., the participant's performance as a reviewer, including their reliability, may be computed as described with respect to FIG. 8. The judgement-score of a participant may be used to guide the assignment process 400 according to which the hub 230 may determine which participant may review which other participant. For example, in the case of a participant that was found to be consistently biased against a certain demographic group, the system 210 may decide not to assign that participant to review participants in that demographic group and/or may decide that that participant's reviews may be redacted from the review data. In an aspect, reviewers that were found to be highly reliable (with high judgement-scores) may be grouped with highly skilled reviewees.

FIG. 10 demonstrates data structures of reviews provided by participants of a group session 1010, according to an aspect of the present disclosure. In an aspect, during the course of one round (e.g., round 150.1 of FIG. 1), a session 1010 (e.g., session 140.1 of FIG. 1) may generate reviews that may be assembled in data structures 1040, 1050, and may be stored in the repository 260 for further processing, as disclosed with respect to FIG. 8, for example. As shown in FIG. 10, one participant of session 1010, serving as a reviewer 1020, may be identified by the system 210 with ID=1. Another participant of session 1010, serving as a reviewee 1030, may be identified by the system 210 with ID=2. During the session 1010, the reviewer 1020 and the reviewee 1030 may generate their respective review data Rᵢ={rᵢ, cᵢ, dᵢ, rsᵢ} and Cᵢ={rᵢ, cᵢ, dᵢ,csᵢ}. These reviews may then be stored in data structures, respectively, 1040 and 1050. Each row of each of these data structures may store data with respect to one review, i, wherein one or more reviews may correspond to a discussion (including questions 1140.1-1140.n, responses, follow-up questions 1142, further responses, conducted with respect to a certain topic 1120) and each review may provide a score with respect to a skill dᵢ related to the discussed topic. Thus, at the end of a discussion of a topic, both the reviewer and the reviewee may provide their respective scores, rsᵢ and csᵢ that may be stored in the respective data structures 1040 and 1050. In a first column of the data structures 1040, 1050, a review's index, i, may be stored. In a second column of the data structures 1040, 1050, the identity of the reviewer rᵢ associated with review i may be stored, and in the third column the identity of the reviewee cᵢ associated with review i may be stored. In the fourth column, a skill dᵢ that is being tested in review i may be stored. And, in the fifth column, of 1040 and 1050, the scores provided respectively, by a reviewer 1020 and a reviewee 1030, that is rsᵢ in data structure 1040 and csᵢ in data structure 1050, may be stored.

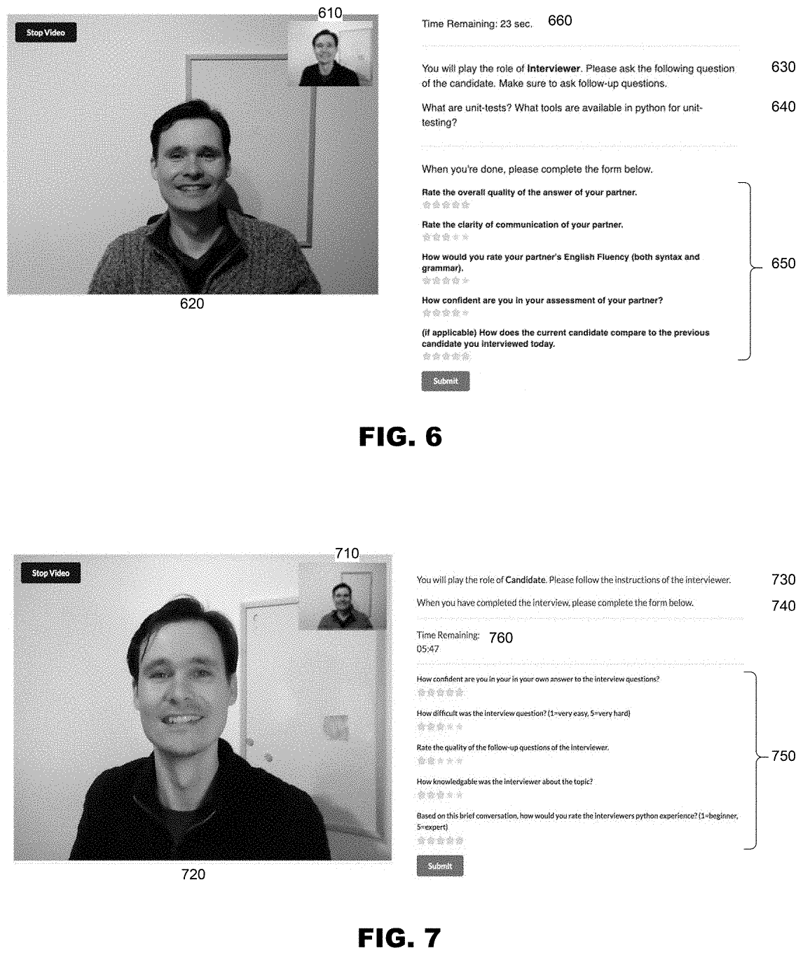

FIGS. 6-7 demonstrate a review session as experienced by two participants, users of the review system 210. In an aspect, both participants are candidates pursuing the same position, for example, a position for a Python programmer at a certain company. A client-application, hosted on each candidate's device 220, 920 may enable teleconferencing (e.g., via the hub's communication unit 935) with which the candidates may view and hear each other and communicate via video, audio, and text. As disclosed herein, the candidates may interact with each other according to their respective role and in accordance with instructions they receive from the prompter 240. In an aspect, a session may include several sets of instructions (or discussions), each set may include instructions to ask initial and follow-up questions designed to test a certain skill. The testing of skills with respect to a certain topic may be limited by a certain allotted time 660, 760, at the end of which the interviewer and candidate may be asked to provide their respective feedback. Each feedback—that is a provided review (scoring) with respect to a tested skill—may be stored in a data structure 1040, 1050 in the repository 260 for further processing. Feedback data associated with the participants' interactions may be also collected based on video and audio recordings of the interactions that are buffered 270 and analyzed by the video/audio analyzer 280.

FIG. 6 shows the client-application's display as viewed by a session participant 610 that is assigned with the role of an interviewer 630 (reviewer). The interviewer 610 may see on his display a video of another participant of the same session that is assigned the role of a candidate 620. Thus, in an aspect, at the beginning of the session, a reviewer may receive initial instructions 640 based on which he may pose questions to a reviewee. After a certain amount of time, additional instructions may be presented to the reviewer based on which he may pose follow-up questions. The additional instructions may be based on calibration data that may be derived from real-time analyses of video and/or audio captures of the interactions (e.g., the answers received from the reviewee in response to the questions posed by the reviewer). Thus, various features may be extracted from the video/audio captures based on their analyses 280, may be stored in the repository 260, and may be further processed 250 to facilitate the calibration data.

For example, the audio capture may be transcribed into text, and, then, phrases or keywords related to the tested skill (e.g., Python) may be detected. The frequency of the sought-after phrases or keywords in the text may suggest the intensity or relevancy of the discussion (e.g., a feature measuring the time spent by a participant discussing certain keywords may be measured). In an aspect, in response to the absence (or presence) of certain phrases or keywords in the transcription, a participant may be presented with instructions to ask follow-up questions about the keywords, as further explained with respect to FIG. 11. In another aspect, if one participant is found to be dominating the conversation (speaking more than a given threshold) the other participant may receive instructions to interject.

Once questions (both initial questions 640 and follow up questions) asked with respect to a certain tested skill have been answered (or at the end of an allotted time), the interviewer may be asked to provide a review. For example, as shown in FIG. 6, the interviewer may be requested to rate the candidate with respect to the quality of his answers, clarity of the communication, or fluency of the language. The interviewer may also be asked how confident he is in his assessment and to compare the candidate to another candidate the interviewer interviewed in a previous session. Based on the interviewer's ratings, review data may be generated and may be stored in a data structure 1040 in the repository 260 for further processing. The review data, may be denoted by Rᵢ={rᵢ, cᵢ, dᵢ, rsᵢ}, including the interviewer identity, rᵢ, the reviewee identity, cᵢ, the skill under review, dᵢ, and the skill-score, rsᵢ. In this example, the skill under review may be competency with respect to a topic related to Python (accuracy and completeness of the answers) or communication skills with respect to the topic related to Python (clarity and fluency).

FIG. 7 shows the client-application's display as viewed by a session participant 710 that is assigned with the role of a candidate 730 (reviewee). The candidate 710 may see on his display a video of another participant of the same session that is assigned the role of an interviewer 720. The candidate may respond to the questions of the interviewer 720, as explained with respect to FIG. 6. When the interviewer concludes his questioning with respect to a certain tested skill (e.g., Python), or if an allotted time 760 is expired, the candidate may also be asked to provide feedback 750. For example, the candidate may be asked how confident he is in his answers, how difficult the questions were, how knowledgeable or experienced the interviewer was with respect to the tested skill. The rating provided by the candidate 710, may be denoted by Cᵢ={rᵢ, cᵢ, dᵢ,csᵢ}, including csᵢ, a skill-score made by the candidate with respect to the interviewer. In an aspect, the candidate's rating, csᵢ, may be used to scale the scoring, rsᵢ offered by the interviewer.

In an aspect, some sessions may be carried out in which, instead of presenting to participants each other's video image, the review system 210 may replace a participant's image with an avatar. The avatar may be either a static figure or an animated figure, e.g., animated based on the video image of the participant it represents. In an aspect, each participant may select whether the participant wishes that an avatar be used to replace the participant's video image. In another aspect, the system 210 may randomly determine a subset of sessions in which avatars may be used, and compare reviews provided by participants in sessions in which avatars were used and in sessions in which avatars were not used.

FIG. 8 is a method 800 for computing skill-scores 540, 550 and judgement-scores 570 for participants, users of the peer-to-peer review system 210, according to an aspect of the present disclosure. Using an optimization algorithm, the method 800 may compute an estimate Sᵢ for each skill-score rsᵢ with respect to a certain skill dᵢ=d−e.g., a topic, 1120 or 1130, related to the subject matter of the review 1110. To that end, the method 800 may begin with extracting from feedback data (e.g., the reviews' data structure 1040) those N reviews for which dᵢ=d, that is Rᵢ={rᵢ, cᵢ, d, rsᵢ} (Box 810). The method 800 may initialize parameters that may be used for the optimization algorithm: P(j), w(j), and q (Box 820). P(j) is a vector that may be defined for each participant j; w(j) is a weight that may be defined for each participant j and may be initialize to 1; and q may be a global parameter, for example, α.

The method 800 may proceed to find the optimization parameters P(j), w(j), and q in an iterative process described with respect to Box 830 and 840. Thus, the method 800 may compute an estimate for the skill-score provided in each review Rᵢ, that is an estimate Sᵢ of rsᵢ (Box 830). The estimate Sᵢ may be a function of P=(j=rᵢ), P(j=cᵢ), and q, as follows:

Sᵢ=ƒ(P(rᵢ),P(cᵢ),q), (1)

where the function ƒ(⋅) may be a functional, i.e., mapping the vectors P(rᵢ), P(cᵢ), and q into the scalar Sᵢ.

In an aspect, q may be the set {α, β, γ} and Sᵢ may be a linear combination, such as:

Sᵢ=βP(ri)+γP(ci)+α, (2)

where β and γ are vectors, and α is a scalar.
In an aspect, a vector P(j) of a participant j may be defined as: P(j)=[b(j), s(j)], where b(j) may be a parameter representing the bias of participant j with respect to the skill being tested d, and s(j) may be a parameter representing a score attributed to participant j with respect to the skill being tested d. Thus, where P(j)=[b(j), s(j)] and q=α, for example, equation (2) translates to

Sᵢ=b(j=ri)+s(j=ci)+α. (3)

Then, in Box 840, parameters P(j) and q may be found to be those parameters that minimize a function L that measures the error in the estimation of the skill-score. For example, L may be defined as:

$$L = \frac{1}{N} {\sum }_{i = 1}^{N} {( {S}_{i} - r {s}_{i} )}^{2} w ( {r}_{i} ) + R ( P , q ) , \qquad ( 4 )$$

where R may be a regularization function. Once parameters P(j) and q that minimize L are found, the weights may be updated. For example, w(j) may be updated by w(j)=α/(MSE(j)+b), where α and b are predetermined parameters and MSE(j) is the mean square error associated with the reviews made by participant j, as follows:

$$MSE ( j ) = \frac{1}{M} {\sum }_{i ∈ Ω} {( {S}_{i} - r {s}_{i} )}^{2} , \qquad ( 5 )$$

where Ω is the set of M reviews for which participant j is a reviewer, that are Rᵢ={rᵢ=j, cᵢ, dᵢ, rsᵢ}. Then, according to the method 800, the optimization process in Boxes 830 and 840 may be repeated until the weights w(j) converge into a stable level or until a predetermined number of iterations is reached.

The method 800 may conclude with the computation of a skill-score 850 and a judgement-score 860 for each participant. In Box 850, the overall performance of a participant j with respect to a skill d may be computed based on the estimate Sᵢ, including only those reviews i for which participant j served as a reviewee, cᵢ=j, as follows,

$$S ( j ) = \frac{1}{M} {\sum }_{i ∈ Ω} f ( P ( {r}_{i} ) , P ( {c}_{i} = j ) , q ) , \qquad ( 6 )$$

where Ω is the set of M reviews for which participant j is a reviewee, i.e., Rᵢ={rᵢ, cᵢ=j, d, rsᵢ}.

In an aspect, S(j) may be computed also as

$$S ( j ) = \frac{1}{M} {Σ}_{i ∈ Ω} r {s}_{i} , \qquad ( 7 )$$

where Ω is the set of M reviews for which participant j is a reviewee, i.e., Rᵢ={rᵢ, cᵢ=j, d, rsᵢ}.

In Box 860, the reliability R(j) of a participant j when serving as a reviewer, namely a participant's judgement-score, may be computed as a function of the weight associated with participant j, w(j). For example, the judgement-score may be computed as a linear combination of w(j), as follows,

R(j)=c*w(j)+b. (8)

In an aspect, the function ƒ(⋅) of equation (1) may be modeled by a neural network. For example, the parameter vector P(j) may be defined as an embedding-vector, wherein the dimensionality of the vector may be determined through cross-validation. The global parameter q may be defined as the weights of the neural network.

In another aspect, the function ƒ(⋅) of equation (1) may be factored into two functions, as follows,

Sᵢ=g(P(cᵢ),q)+h(P(rᵢ),q). (9)

In yet another aspect, function g(⋅) and/or function h(⋅) may be modeled by a neural network, as described above with respect to function ƒ(⋅).

Video and/or audio 226 recordings of sessions, that may be buffered 270 and may be analyzed 280 by the review system 210, may be used to train a machine learning system, according to aspects of the present disclosure. Accordingly, video/audio analysis data that may be generated and stored 260 during operations of the review system 210 and corresponding review data 1040, 1050 may be used as a training set for machine learning models that may be used to predict future participants' evaluation results based on data collected when these future participants interact via the review system 210.

In an aspect, a training set may comprise any of the data in (a) or (b) and any of the corresponding data in (c), (d), (e), or (f):
a) S(j) (e.g., as computed by equation (6) with respect to each skill dᵢ),
b) R(j) (e.g., as computed by equation (8) with respect to each skill dᵢ),
c) review data provided by a reviewer Rᵢ={rᵢ, cᵢ, dᵢ, rsᵢ},
d) review data provided by a reviewee Cᵢ={rᵢ, cᵢ, dᵢ, csᵢ}.
e) features extracted from a video recording of sessions' parts that capture interactions carried out by a reviewer and/or a reviewee with respect to the testing of skill dᵢ, or
f) features extracted from an audio recording (and/or text transcript of the audio recording) of sessions' parts that capture interactions carried out by a reviewer and/or a reviewee with respect to the testing of skill dᵢ.

Hence, in an aspect, S(j) and R(j) may be predicted based on a machine learning based model that may be trained based on a training set, as the one described above. In such a case, predictions of S(j) and R(j) for future sessions may be computed based on data extracted from these future sessions, for example any of the data described in sections (c)-(f) above.

In an aspect, a machine learning model may be used to estimate the skill-score of a certain review rsᵢ—denoted as S_{MLi}. Thus, a hybrid may be used wherein equation (1) may be augmented as follows:

Sᵢ=ƒ(P(rᵢ),P(cᵢ),S_{MLi},q). (10)

Aspects disclosed herein are described above with respect to group sessions comprising participants acting in roles of a reviewer and a reviewee. However, aspects of this invention are not so limited. In further aspects, the review system disclosed herein with respect to FIGS. 1-11, may review contributions of participants engaged in a collaborative task. For example, a collaborative task may be a problem that participants are tasked with solving collaboratively. In this case, participants that may be assigned to the same group may be interacting with each other as a team to accomplish a common goal (e.g., solving a posed problem). Then during or at the end of the interactions, the participants may be asked to score their peers in the group (e.g., grading their effectiveness, level of contribution, collaborative behavior, etc.) in a manner similar to that described herein with respect to FIG. 1-11. Hence, in such an application of the techniques described herein, multiple roles may be assigned to participants of a group. For example, roles may be assigned according to type of expertise (a biologist, a computer-scientist, an artist, etc.) and/or roles may be assigned according to responsibilities (group leaders or followers). Accordingly, in each round, each participant may be assigned with one role, may be interacting with respect to her assigned role, and may be scoring the other participants in the group session from a perspective of her assigned role.

During the operation of the review system 210, across consecutive rounds, the system may accumulate information about each participant's knowledge of the subject matter under review and each participant's reliability as a reviewer. As disclosed above, such information may be derived from analyses of the feedback data—e.g., based on the computed participants' skill-scores and judgement scores. The system may use the accumulated information about the participants to control the assignment of participants into groups at the beginning of each round and to control calibration of ongoing sessions within each round. In an aspect, the system 210 may affect the manner in which, for each round, the assignment to groups is made and the role of each participant is assigned. Thus, the creation of groups in a current round may be affected by analyses of feedback data generated in prior rounds. For example, reviewers may be matched with reviewees of a similar skill level, or highly reliable reviewers may be matched with reviewees that in previous rounds were reviewed by less reliable reviewers. The system may also utilize its knowledge of participants' performances in previous rounds (e.g., their skill-scores and judgement-scores) to determine what instructions may be issued to each participant in a current round, so that each participant may be more likely to successfully perform the issued instructions.

The system 210 may also affect the instructions each participant may receive during ongoing sessions within a round. Such instructions may be altered based on timing. Alternatively, or in addition, such instructions may be altered based on analysis of the interactions in the ongoing session, for example, based on the detection of keywords or based on speech pattern detection. Based on the detection of keywords, the system may issue further instructions to the participants. For example, if certain keywords are not detected in the transcription of audio capturing a participant's ongoing response, after a certain amount of time the participant may be prompted to discuss these keywords, or the other participant may be prompted to inquire about these keywords. Likewise, if a specific keyword of high importance is detected, the participant may be prompted to provide more detail, or the other participant may be prompted to further inquire about the important keyword. Based on speech pattern detection, the system may further control the amount of time a participant may talk before the participant may be instructed to let the other participant respond or before the other participant may be instructed to interject. For example, if a reviewer is talking more time than a certain time threshold, the system may suggest that the reviewer give the reviewee more time to answer the question.

In an aspect, instructions provided by the system 210 may be presented to each participant in the form of images, video, audio, or text. For example, an instruction may be a directive such as “your partner is going off on a tangent, try to interrupt them and get them back on track.” The instruction may be providing a hint to a participant responding to a question, such as “the elements of a good answer include . . . ” An instruction may be a specific follow up question, such as “ask about topic X.” Further, the system may prompt each participant to interject into a discussion or to pose and let the other initiate or respond to an interaction to maintain balanced interactions, ensuring that each participant is provided with enough opportunities to respond to a question or demonstrate her contribution.

In an aspect, embodiments of systems described herein may include computer software. For example, systems 200, 900 of FIGS. 2, 9, or elements thereof, may be embodied in computer software instructions stored in a computer memory or other storage medium, and the instructions may be executed by processor. Methods such as 300, 400, 800, may be stored as in a computer memory as instructions, that when executed by a processor, cause the methods to be performed.

Several aspects of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A method, comprising:
assigning participants, set to interact with each other via a communication system, into groups of a round, each group comprises participants set to interact in a group session as a reviewer or as a reviewee;
providing each participant in a group with instructions, based on which the participant interacts with another participant in the group during a respective group session;
receiving feedback data associated with interactions among the participants during respective group sessions;
generating calibration data based on the received feedback data; and
based on the calibration data, assigning participants, set to interact with each other via the communication system, into groups of a further round.

2. The method of claim 1, wherein the providing each participant in a group with instructions comprises:
providing each participant with a predefined number of instructions at a predefined rate.

3. The method of claim 1, further comprising:
updating the instructions provided to the each participate based on the calibration data.

4. The method of claim 3, wherein the providing each participant in a group with instructions further comprises:
recording audio of an interaction performed by the participant during the respective group session;
extracting features out of the audio indicative of the quality of the interaction; and
providing the participant, or another participant the interaction directed at, with an instruction based on the quality of the interaction.

5. The method of claim 1, wherein the feedback data comprise reviews, each review comprising information of a reviewer identity, a reviewee identity, a skill, and a skill-score.

6. The method of claim 1, wherein the feedback data comprise records of video, recording interactions among the participants during respective group sessions.

7. The method of claim 1, wherein the feedback data comprise records of audio, recording interactions among the participants during respective group sessions.

8. The method of claim 1, further comprising:
computing a skill-score of a participant based on feedback data associated with group sessions wherein the participant interacted as a reviewee.

9. The method of claim 1, further comprising:
computing a judgment-score of a participant based on feedback data associated with group sessions wherein the participant interacted as a reviewer.

10. The method of claim 1, wherein the assigning participants into groups of the further round is further based on:
a skill-score and a judgement-score of the participants, wherein a skill-score and a judgement-score of a participant is computed based on feedback data associated with previously assigned group sessions wherein the participant interacted, respectively, as a reviewee or as a reviewer.

11. A system, comprising:
a hub, having an input for log-in data of a plurality of participants and an output for assignment data, the hub is configured to group participants of the plurality of participants into groups according to the assignment data and to communicatively connect participants of each group, wherein each group comprises a reviewer and a reviewee set to interact in a session;
a prompter, having an input for the assignment data and an output for instructions to each of the groups, based on which the participants of each of the groups interact during a session, the instructions are derived from calibration data; and
a moderator, having an input for feedback data associated with participants' interactions and an output for the calibration data generated based on the feedback data.

12. The system of claim 11, wherein the instructions include providing each group with a predefined number of instructions at a predefined rate.

13. The system of claim 11, wherein the instructions based on the calibration data.

14. The system of claim 13, wherein the system:
records audio of an interaction performed by the participant during the respective group session;
extracts features out of the audio indicative of the quality of the interaction; and
provides the participant, or another participant the interaction directed at, with an instruction based on the quality of the interaction.

15. The system of claim 11, wherein the feedback data comprise reviews, each review comprising information of a reviewer identity, a reviewee identity, a skill, and a skill-score.

16. A memory storing computer readable instructions that, when executed by a processor, cause:
assigning participants, set to interact with each other via a communication system, into groups of a round, each group comprises participants set to interact in a group session as a reviewer or as a reviewee;
providing each participant in a group with instructions, based on which the participant interacts with another participant in the group during a respective group session;
receiving feedback data associated with interactions among the participants during respective group sessions;
generating calibration data based on the received feedback data; and
based on the calibration data, assigning participants, set to interact with each other via the communication system, into groups of a further round.

17. The memory of claim 16, wherein the providing each participant in a group with instructions comprises:
providing each participant with a predefined number of instructions at a predefined rate.

18. The memory of claim 16, wherein the instructions further cause:
updating the instructions provided to the each participate based on the calibration data.

19. The memory of claim 18, wherein the providing each participant in a group with instructions further comprises:
recording audio of an interaction performed by the participant during the respective group session;
extracting features out of the audio indicative of the quality of the interaction; and
providing the participant, or another participant the interaction directed at, with an instruction based on the quality of the interaction.

20. The memory of claim 16, wherein the feedback data comprise reviews, each review comprising information of a reviewer identity, a reviewee identity, a skill, and a skill-score.
